(19) United States
(12) Patent Application Publication
(10) Pub. No.: US 2005/0174643 A1
(43) Pub. Date: Aug. 11, 2005

(54) Hybrid lens array and method of fabricating the same

(75) Inventors: Myung-bok Lee, Suwon-si (KR); Jin-seung Sohn, Seoul (KR); Mee-suk Jung, Suwon-si (KR); Eun-hyoung Cho, Seoul (KR); Hae-sung Kim, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/053,898

(22) Filed: Feb. 10, 2005

(30) Foreign Application Priority Data
Feb. 11, 2004 (KR) 10-2004-0008923

(51) Int. Cl. G02B 27/44

(52) U.S. Cl. 359/566; 359/558

(57) ABSTRACT

Provided are a hybrid lens and method of fabricating the same. A hybrid lens designed as a combination of a refractive lens and a diffractive lens includes a refractive lens including a first spherical surface and a second planar surface, a diffractive lens that is bonded onto the first surface of the refractive lens and includes a refractive portion for correcting spherical aberration, and a lens holder attached to an outer perimeter of the first surface of the refractive lens. The method eliminates the need for high temperature heating or cooling or a high pressure process while allowing rapid and simple processing at room temperature under low pressure and thus high volume production.

### BACKGROUND OF THE INVENTION

This application claims the priority of Korean Patent Application No. 10-2004-0008923, filed on Feb. 11, 2004, in the Korean Intellectual Property Office, the disclosure of which is incorporated herein in its entirety by reference.

1. Field of the Invention

The present invention relates to a hybrid lens array and method of fabricating the same, and more particularly, to a hybrid lens with corrected aberrations that can be used in an optical pickup in an optical storage device and a method of fabricating the same.

2. Description of the Related Art

An objective lens for an optical pickup in an optical storage device focuses a laser beam emitted by a semiconductor laser used as a light source onto a recording surface of a disc in order to record information onto the disc and refocuses a beam reflected from the disc onto a photodetector in order to reproduce information from the disc. While a Compact Disc (CD) with a diameter of 12 cm can typically store up to 650 MB of data, a Digital Versatile Disc (DVD) has the same physical size but has a storage capacity of 4.7 GB. A Blu-ray Disc (BD) is the proposed successor to DVD and can hold up to 25 GB of data.

To increase the information storage capacity of an information storage medium with the same physical size, it is necessary to increase the recording density by focusing an optical energy to a smaller spot. Since the focal spot size is proportional to the wavelength of laser light and inversely proportional to the numerical aperture (NA) of a lens, optical storage systems have been developed to increase the NA of the lens and decrease the wavelength. For example, CDs use a light source with a 780 nm wavelength and an objective lens with 0.45 NA while DVDs use a light source with 650 nm wavelength and an objective lens with 0.6 NA. BDs need a light source with 405 nm wavelength and an objective lens with 0.85.

The refractive index of an objective lens varies significantly with a wavelength in the 405 nm wavelength region for a BD. The problem occurs when the focal length of an objective lens varies due to instantaneous wavelength variation caused by mode hopping in a laser diode (LD), which is called a chromatic aberration. To reduce chromatic aberration, a hybrid refractive-diffractive lens has been proposed.

Optical storage devices can be backward read compatible with lower capacity optical discs. For example, a DVD player may read CDs and a BD player can play DVDs and CDs. As an example of a hybrid lens, a hologram-integrated dual focus lens has been developed in which a single lens is used to change a focal length to play both CD and DVD.

FIG. 1 is a schematic diagram of a conventional hologram-integrated dual focus objective lens designed to simultaneously read CD and DVD. Referring to FIG. 1, an incident beam 11a indicated by a solid line is focused onto a recording surface 13a of a 0.6 mm thick optical disc when reading a DVD disc. An incident beam 11b indicated by a dotted line is focused onto a recording surface 13b of a 1.2 mm optical disc when reading a CD. That is, information recording and reproducing is made for a DVD disc using refraction of light at an outer perimeter 12a of a lens 12 with 0.6 NA and a zero-order diffracted beam produced by a diffractive lens at the inner perimeter 12b. On the other hand, information recording and reproducing are made for a CD using a positive first-order diffractive lens produced by a diffractive lens at an inner perimeter 12b of the lens 12 with 0.45 NA.

A conventional microlens manufacturing method involves directly grinding or cutting glass or plastic material. For mass production of objective lenses, injection molding or press molding is used to inject or press molten or semi-molten plastic or glass into a mold made by machining such as cutting or grinding. FIG. 2 is a schematic diagram of a conventional device for fabricating a single microlens using the machining method.

A method of fabricating a single glass lens by a conventional press molding process will now be described with reference to FIG. 2. First, upper and lower molds 21 and 22 made of hard metals are very precisely grinded into a shape corresponding to the surface of a lens, and then glass ball (BL) preform or a gob (G) of glass preform is inserted between the upper and lower molds 21 and 22, heated to a high temperature of 500 to 600° C., and pressed by the upper and lower molds 21 and 22, thereby forming the lens.

Molding using precision molds in this way enables an ultra-precise lens surface to be formed. However, as the diameter of a lens decreases, it becomes more difficult to fabricate a mold for a lens with a high numeral aperture, i.e., a high-curvature aspheric surface due to restrictions on the radius of curvature of a tool. This glass molding requires an extremely lengthy cycle time in uniformly and internally heating a preform material, thereby lowering productivity.

A hologram-integrated glass-molded lens is fabricated using substantially the same method as illustrated in FIG. 2, but there is a difference in a method of making a mold corresponding to a curved lens surface on which a hologram is formed. To form a curved surface corresponding to a lens aspheric surface, an aspheric surface of a hard metal mold is machined by a diamond grinding wheel and then concentric circles corresponding to a holographic pattern are cut by a bite. However, this causes extreme wear on the bite. As a solution to this problem, a method of fabricating the upper mold 21 shown in FIG. 2 will now be described with reference to FIGS. 3A and 3B.

Referring to FIGS. 3A and 3B, an aspheric surface of a preform 31 corresponding to a curved surface of a lens is roughly machined, and then metal with good machinability such as a nickel(Ni) electrolessly plated layer 32 are formed thereon. Then, the Ni plated layer 32 is cut into a curved aspheric surface and a holographic pattern by a diamond cutting bite 33, on which a protective layer 34 is coated. When a glass lens is fabricated with a mold on which a holographic pattern has been engraved, high temperature and pressure are required to achieve good geometrical transferability due to low fluidity of a glass material. This results in short lifespan of a mold, low lens fabrication efficiency, and high manufacturing costs. For a glass-molded lens, a minimum pitch of a hologram is limited to about several tens of micrometers, and it is difficult to improve optical aberrations due to restrictions on geometrical transferability caused by low fluidity of glass.

Conversely, when a hologram-integrated lens is fabricated by filling a mold with plastic material, it is easy to fabricate the mold by cutting a mold made of metal having good machinability such as Ni as well as to form a precise holographic pattern. Plastic molding is carried out at temperature less than 300° C. and allows easy and precise fabrication of a hologram-integrated objective lens with a low minimum pitch due to excellent fluidity of plastic material. In addition, since the plastic lens is lightweight, easy to machine, and has low manufacturing costs, it is useful for a pickup lens for both CD and DVD.

However, low refractive index (1.5) and insufficient light refractive power of plastic material requires the use of two overlapping lenses to fabricate a lens with 0.85 NA for BD. Adjusting the positions of the two lenses for assembling costs more than using a single lens. Another drawback is that heat-sensitive plastic material undergoes extreme variation in optical characteristics (refractive index, thermal expansion coefficient, etc.) and the phenomenon of yellowing caused by absorption of blue light over a long period of time, which leads to a change in material characteristics.

To overcome these problems, a hologram-integrated objective lens constructed as shown in FIG. 4 has been proposed. The objective lens is constructed to bond a glass molded lens 40 with two aspheric surfaces, i.e., an entrance surface 40a and an exit surface 40b to a plastic lens with a diffractive optical element 41 including two holographic diffractive optical elements 41a and 41b situated on the entrance and exit surfaces 40a and 40b, respectively. Fabrication of the glass/plastic hybrid lens involves forming a glass-molded lens with two aspheric surfaces by typical press molding, applying a UV curable resin within a metal mold having an engraved holographic pattern, placing the glass-molded lens into the metal mold, pressing another mold onto the glass-molded lens, irradiating the same with UV light, and attaching a plastic holographic pattern onto a glass curved surface. This method includes the step of bonding a plastic holographic structure by photo-polymerization (2P) process in addition to a conventional glass lens fabrication method.

However, this method has difficulties in manufacturing since a relative position of a glass lens relative to a mold and parallelism therebetween must be precisely adjusted to prevent a lens tilt and decenter between the glass lens and the holographic pattern. Another problem is that it is difficult to ultra-precisely fabricate molds for glass molding and 2P when fabricating a microscopic lens with a diameter less than 1 mm and to align and adjust the position of a glass lens for a 2P process.

### SUMMARY OF THE INVENTION

The present invention provides a hybrid lens with a high numerical aperture and a low chromatic aberration and a method of fabricating the same that allows simple and low cost fabrication.

The present invention also provides a hybrid lens that can be used in optical pickups for all sizes and types of optical storage devices including that using a 405 nm blue light, 0.85 NA lens, and a microscopic optical disc and a method of fabricating the same.

According to an aspect of the present invention, there is provided a hybrid lens including a refractive lens including a first spherical surface and a second planar surface, a diffractive lens that is bonded onto the first surface of the refractive lens and includes a refractive portion for correcting spherical aberration, and a lens holder attached to an outer perimeter of the first surface of the refractive lens. The lens holder is attached to a portion of the first surface near a boundary between the first and second surfaces of the refractive lens.

While the refractive lens is a half ball lens made of glass, the diffractive lens is made of polymer or an inorganic sol-gel material that can be cured by ultraviolet (UV) radiation. The lens holder is made of UV curable polymer or thermosetting polymer. The hybrid lens may further include a substrate holder disposed beneath the second surface of the refractive lens and the holder.

According to another aspect of the present invention, there is provided a method of fabricating a hybrid lens including the steps of: (a) applying a first material within a cavity of a mold including at least one cavity with a diffractive lens pattern and placing a ball lens on the first material; (b) pressing the ball lens with a transparent plate and curing the first material; (c) applying a second material on the mold and the ball lens, pressing the ball lens with a transparent plate, and curing the second material; and (d) separating the mold from the second material and the ball lens and polishing portions of the second material and the ball lens.

The first material is a polymer or an inorganic sol-gel material that can be cured by ultraviolet (UV) radiation. In the step (b), the first material is irradiated with UV light from above the transparent plate to cure it.

The second material is UV curable or thermosetting polymer. In the step (c), the ball lens and the second material are pressed with the transparent plate and irradiated with UV light from above the transparent plate or heated to cure the second material.

According to still another aspect of the present invention, there is provided a method of fabricating a hybrid lens including the steps of (a) applying a first material within a cavity of a mold including at least one cavity with a diffractive lens pattern and placing a half ball lens on the first material; (b) applying a second material on the mold and the half ball lens, pressing the half ball lens with a transparent plate, and curing the second material; and (c) separating the mold from the second material and the half ball lens.

According to yet still another aspect of the present invention, there is provided a method of fabricating a mold for a hybrid lens including the steps of: (a) applying photoresist over a substrate and removing predetermined portions of the photoresist to form grooves; (b) removing a portion of the substrate by isotropic etching through the groove and removing the photoresist to create a hemispherical cavity on the substrate; and (c) pressing a cavity with a mold having a diffractive lens pattern and forming a diffractive lens pattern within the cavity.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a conventional hologram-integrated objective lens;

FIG. 2 illustrates a method of fabricating a single microlens using conventional machining;

FIGS. 3A and 3B illustrate a method of fabricating a mold for a conventional hologram-integrated objective lens;

FIG. 4 is a schematic diagram of a conventional hologram-integrated objective lens;

FIGS. 5A and 5B illustrate a hybrid lens according to an embodiment of the present invention;

FIGS. 6A-6G illustrate a method of fabricating the hybrid lens of FIG. 5 according to an embodiment of the present invention;

FIGS. 7A-7G illustrate a method of fabricating the hybrid lens of FIG. 5 according to another embodiment of the present invention;

FIGS. 8A-8F illustrate a method of fabricating a mold for a hybrid lens according to an embodiment of the present invention; and

FIGS. 9A and 9B illustrate a method of operating a hybrid lens according to an embodiment of the present invention.

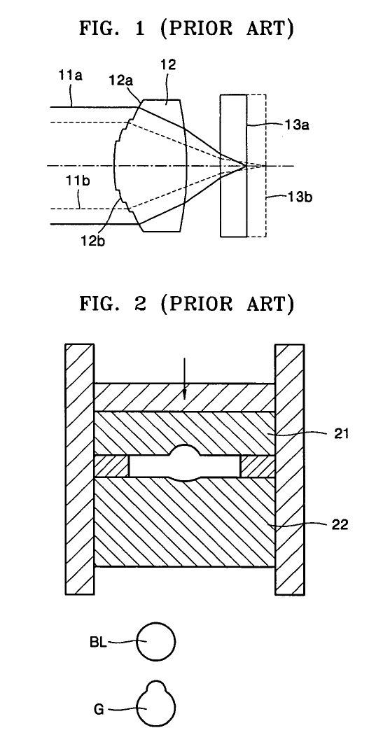

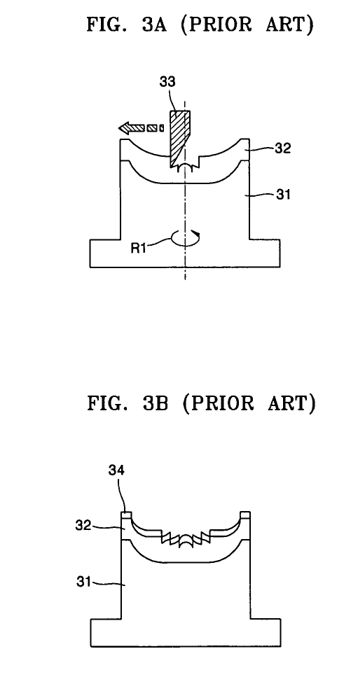

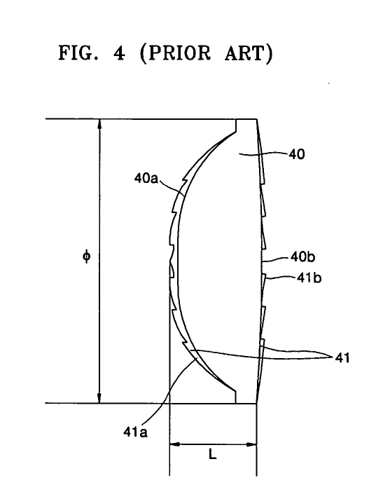

### DETAILED DESCRIPTION OF THE INVENTION

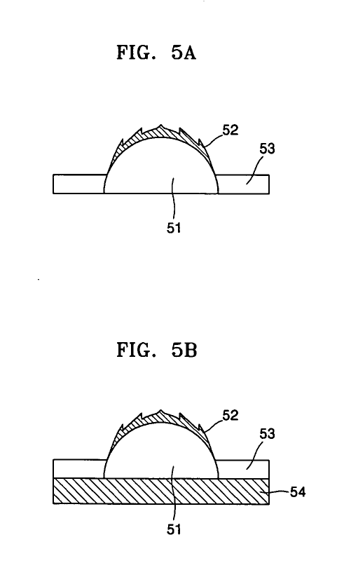

Referring to FIG. 5A, a hybrid lens according to an embodiment of the present invention includes a spherical lens 51 with a first spherical surface and a second planar surface, a diffractive lens 52 bonded to the first surface of the spherical lens 51, and a lens holder 53 attached to a bottom outer perimeter of the spherical lens 51. The diffractive lens 52 has a curved aspheric surface for correcting a spherical aberration of the spherical lens 51 and a diffractive lens pattern formed on the curved aspheric surface. While the spherical lens 51 is made of glass, the diffractive lens 52 is made of ultraviolet (UV) curable polymer. The lens holder 53 of the spherical lens 51 has a doughnut shape or a shape similar to a doughnut and can be made of a plastic material. The plastic material may be a UV curable polymer forming the diffractive lens 52 or other materials. Referring to FIG. 5B, the spherical lens 51, the diffractive lens 52, and the holder 53 may be formed on a holder substrate.

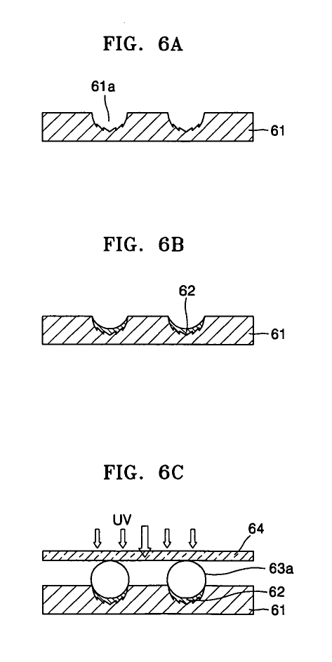

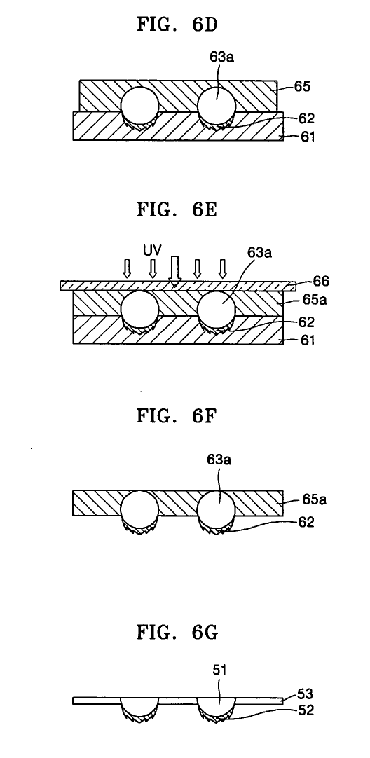

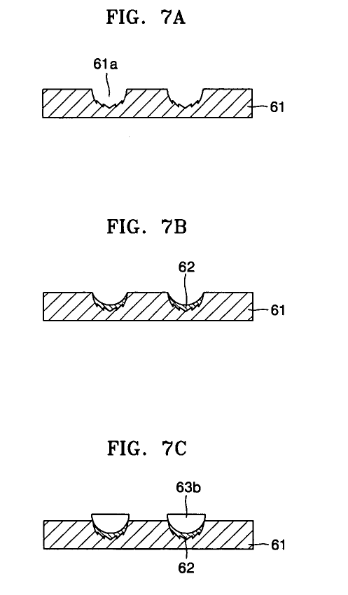

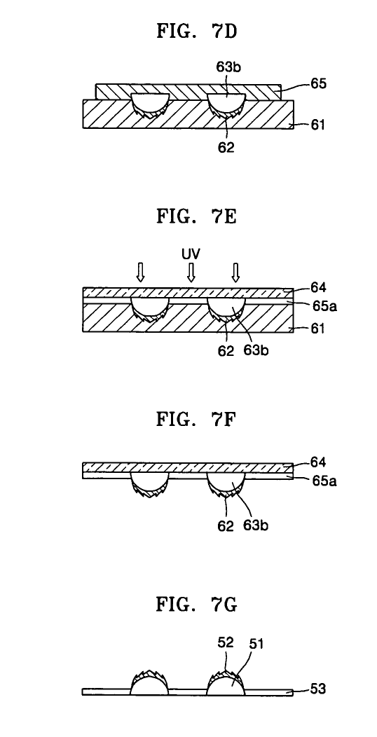

FIGS. 6A-6G and FIGS. 7A-7G illustrate methods of fabricating the hybrid lens of FIG. 5A according to exemplary embodiments of the present invention. Referring to FIG. 6A, first, a mold 61 with desired patterns is created. The desired number of cavities 61a with a pattern corresponding to the shape of the diffractive lens 52 are formed at regular spacing on the surface of the mold 61 to allow fabrication of a single lens as well as an array having a plurality of lenses. Referring to FIG. 6B, a first liquid photopolymer 62 that can be cured under UV radiation is then spin-coated or dispensed within the cavity 61a.

Subsequently, a ball lens 63a is placed within the cavity 61a as shown in FIG. 6C and pressed flatly with a glass plate 64. At the same time, the first photopolymer 62 is irradiated with UV light from above a light-transmissive glass plate 64 to cure it. The ball lens 63a is fixed within the cavity 61a by the first photopolymer 62 cured by UV radiation.

Then, referring to FIG. 6D, a second UV-curable liquid photopolymer 65 is coated on the mold 61 and the ball lens 63a. In this case, the second photopolymer 65 may be made of material other than that of the first photopolymer 62. Next, as shown in FIG. 6E, a glass plate 66 is attached flatly onto the second photopolymer 65 and pressed inward onto the second photopolymer 65 and the ball lens 63a. Simultaneously, the second photopolymer 65 is irradiated with UV light from above the glass plate 66 to cure it and to fix it to the ball lens 63a. Consequently, the ball lens 63a remains completely bonded with the first photopolymer 62 used to correct spherical aberration and form the diffractive lens 52 and the second photopolymer 65 serving as a lens holder.

Next, referring to FIG. 6F, the ball lens 63a and the first UV-cured photopolymer 62 are demolded from the mold cavity 61a to form a second photopolymer 65a surrounded and fixed with the ball lens 63a bonded to the first photopolymer 62 with a curved aspheric lens and a diffractive lens pattern and an array of ball lenses 63a.

Finally, as shown in FIG. 6G, portions of the second photopolymer 65a and ball lens 63a are polished to a predetermined thickness to obtain an array of hybrid lenses as shown in FIG. 5A, each including the spherical lens 51, the diffractive lens 52 bonded onto the first surface of the spherical lens 51, and the lens holder 53 attached to the outer perimeter of the spherical lens 51.

A method of fabricating the hybrid lens of FIG. 5A according to another embodiment of the present invention will now be described with reference to FIGS. 7A-7G. First, referring to FIG. 7A, a mold 61 on which patterns to be fabricated have been formed is created. The desired number of cavities 61a with a pattern corresponding to the shape of the diffractive lens 52 are formed at regular spacing on the surface of the mold 61 in order to fabricate a single lens as well as an array having a plurality of lenses. Referring to FIG. 7B, a first liquid photopolymer 62 that can be cured under UV radiation is then spin-coated or dispensed within the cavity 61a.

Subsequently, a half ball lens 63b is placed within the cavity 61a as shown in FIG. 7C and then a second UV-curable liquid photopolymer 65 is coated on the mold 61 and the half ball lens 63b as shown in FIG. 7D. In this case, the second photopolymer 65 may be made of material other than that of the first photopolymer 62. Next, as shown in FIG. 7E, a glass plate 64 is attached flatly onto the second photopolymer 65 and pressed inward onto the second photopolymer 65 and the half ball lens 63b. Simultaneously, the second photopolymer 65 is irradiated with UV light from above the glass plate 64 to cure it and fix it to the half ball lens 63b. Consequently, the half ball lens 63b remains completely bonded with the first photopolymer 62 used to correct spherical aberration and form the diffractive lens 52 and the second photopolymer 65 serving as a lens holder.

Next, referring to FIG. 7F, the half ball lens 63b and the first UV-cured photopolymer 62 are demolded from the mold cavity 61a to form a second photopolymer 65a surrounded and fixed with the half ball lens 63b bonded to the first photopolymer 62 with a curved aspheric surface and a diffractive lens pattern and an array of ball lenses 63a. Although the glass plate 64 remains attached to the second polymer 65 and the half ball lens 63b when the hybrid lens is in actual use, the glass plate 64 can be removed therefrom to obtain an array of hybrid lenses as shown in FIG. 5A, each including the spherical lens 51, the diffractive lens 52 bonded onto the first surface of the spherical lens 51, and the lens holder 53 attached to the outer perimeter of the spherical lens 51.

The ball lens 63a and the half ball lens 63b used in the processes of fabricating a hybrid lens illustrated in FIGS. 6A-6G and FIGS. 7A-7G, respectively, can be made of materials with high refractive indices (preferably greater than 1.7) and high transmittance (preferably above 90%) to absorb almost no light at a wavelength band of around 405 nm.

The first UV curable polymer 62 that is bonded to the ball lens 63a or the half ball lens 63b and used to correct spherical aberration and form a diffractive lens can be a material with a high refractive index similar to those of the ball lens 63a and the half ball lens 63b and high light transmittance and low absorption at a wavelength band of around 405 nm. The first polymer 62 may be liquid polymer or inorganic sol-gel material that can be cured under UV radiation. The lens holder 53 fixed or connected to the ball lens 63a or the half ball lens 63b may be made of thermosetting polymer, which can be cured by the use of heat, instead of UV curable polymer.

The first UV curable polymer 62 may be a material in the liquid phase to realize a lens with an ultra-precise aspheric surface. The UV curable polymer material can reduce comma aberration caused by a lens tilt and compensate for thickness variations in a ball lens. The UV curable polymer material can show low adhesion to the mold 61 and high adhesion to the ball lens 63a or the half ball lens 63b. Although it is desirable that the UV curable polymer material has low adhesion to the glass plate 64 for horizontal pressing, it can have high adhesion thereto when the glass plate 64 remains attached to the half ball lens 63b for use as shown in FIG. 7F. If the UV curable polymer material does not meet the above requirements during each fabrication process step, proper surface treatment (surface-activated treatment) can be performed on the mold 61, the ball lens 63a, the half ball lens 63b, or the glass plate 64 before UV irradiation to suppress or accelerate adhesion with the UV curable polymer material.

An array of hybrid lenses can be divided into single lenses by dicing the space between unit lenses in an array of hybrid lenses or combined with an optical module array depending on the type of application.

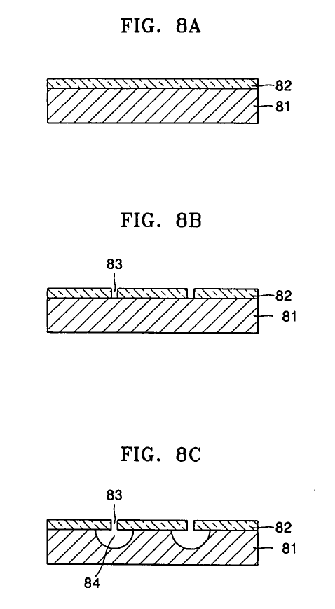

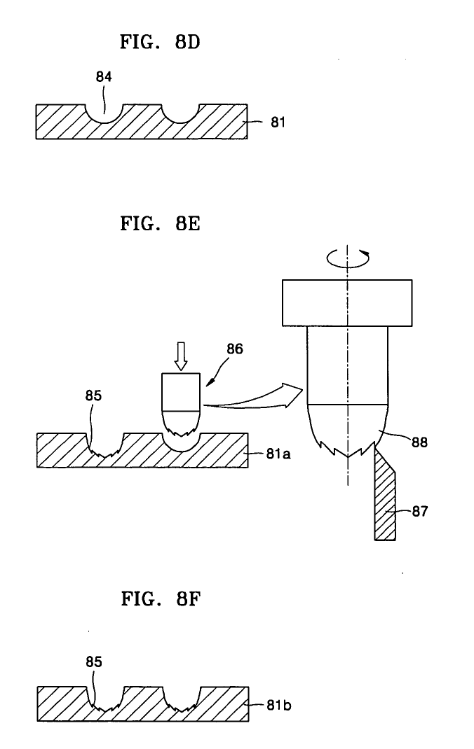

A method of fabricating a mold 61 with an array of cavities, each having an aspheric surface and a diffractive lens pattern, and that can be used in fabricating a hybrid lens according to the present invention will now be described with reference to FIGS. 8A-8F.

First, as shown in FIG. 8A, a substrate 81 on which an array of cavities will be formed is prepared and photoresist 82 is applied over the substrate 81 by spin coating or other coating techniques. The substrate 81 may be made of material such as glass or polymer that will be used for forming an aspheric surface and a diffractive lens pattern.

Then, as shown in FIG. 8B, the photoresist 82 is patterned by a photolithography process commonly used in semiconductor processing to form grooves 83 at positions where the cavities will be formed. Subsequently, as shown in FIGS. 8C and 8D, the substrate 81 is isotropically dry or wet etched symmetrically about the groove 83 using the photoresist 82 as an etch mask layer and then the photoresist 82 is removed from the substrate 81, thereby creating an array of cavities 84 having a semi-hemispherical profile at regular intervals on the surface of the substrate 81.

Then, as shown in FIG. 8E, a metal convex core mold 86 designed to have a pattern 88 corresponding to an aspheric surface and a diffractive lens using ultra-precise cutting such as diamond turning is used to continuously perform press molding into each cavity 84. To achieve an effective press molding process, a portion of each cavity 84 or the entire substrate 81a is heated. After press molding, as shown in FIG. 8F, a mold 81b for fabricating a diffractive lens with an aspheric surface and a diffractive lens pattern 85 is completed.

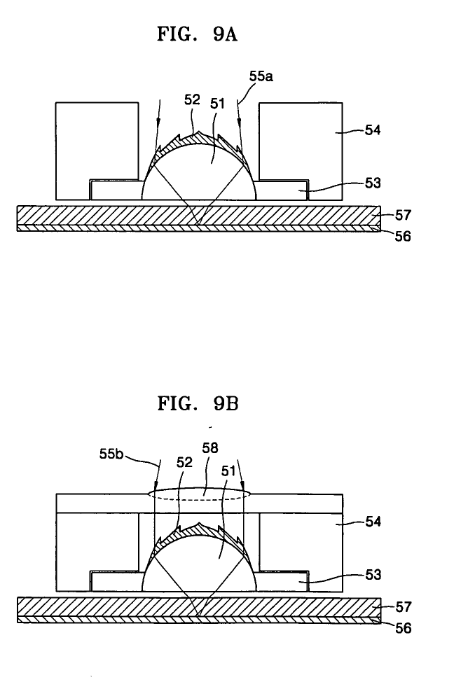

FIGS. 9A and 9B illustrate a hybrid lens in which a holder 53 has been attached to a holder substrate 54 prefabricated to a shape conforming to the shape of the holder 53 after unit hybrid lenses are separated from each other by dicing. The holder substrate 54 may be a wafer with a diameter of several inches or separated by dicing depending on the type of application. A single hybrid lens is seated on the holder substrate 54 with a portion machined to conform to the outer perimeter diameter of the holder 53 and then bonded and assembled therewith by a UV curable adhesive. Referring to FIGS. 9A and 9B, a hybrid lens according to the present invention operates on the following principle.

A beam 55a that is emitted by a light source passes through a beam-shaping element, a beam splitter, and a mirror is incident on the diffractive lens 52 in the hybrid lens and diffracted and refracted onto a recording layer 56 of an optical disc 57. The beam 55a is focused by the hybrid lens to produce a nearly diffraction-limited microscopic spot on the recording layer 56 of the optical disc 57 for recording or reproducing of information. It is desirable to use a parallel beam as the beam 55a incident as shown in FIG. 9A. A collimating lens 58 may be disposed on the holder substrate 54 to collimate a beam 55b incident on the diffractive lens 52 as shown in FIG. 9B into a parallel beam.

Assembling the hybrid lens including a half ball lens 51 and the diffractive lens 52 theoretically requires a level of precision comparable to that required when assembling two lenses. However, in contrast to assembling two lenses, the hybrid lens fabrication process described above can minimize a decenter of each lens surface relative to an optical axis and a surface tilt for the following reasons.

First, the liquid photopolymer 62 with a high degree of fluidity can precisely fill a gap between a curved surface of the cavity 61a and a spherical surface of the ball lens 63a or the half ball lens 63b, thereby realizing ultra-precise aspheric surface and diffractive lens surface.

Second, the hybrid lens fabrication method can minimize a decenter error of the lens by precisely forming a lateral position of each cavity 61a when manufacturing the mold 61. In this case, it is easy to precisely place the ball lens 63a or the half ball lens 63b into the cavity 61a. The present invention allows automatic centering since the lateral position of the ball lens 63a or half ball lens 63b is confined by a boundary of the cavity 61a and it has a minimum energy when-the ball lens 63a and the half ball lens 63b is located at the center of the cavity 61a due to surface tension of the liquid photopolymer 62. Furthermore, by pressing the ball lens 63a or the half ball lens 63b gradually and flatly with the glass plate 64 while maintaining the fluidity of the polymer 62, the ball lens 63a or the half ball lens 63b is seated into the bottom (the lowest position) of the cavity 61a. Thus, when the ball lens 63a or the half ball lens 63b suffers from thickness variations, it is possible to compensate for thickness (height) variations since the liquid polymer 62 serves as a buffer layer to automatically control the longitudinal position of the ball lens 63a or the half ball lens 63b.

Third, the fabrication method illustrated in FIGS. 6A-6G can minimize a tilt of a lens surface since the ball lens 63a is polished to a predetermined thickness. The fabrication methods illustrated in FIGS. 6A-6G and FIGS. 7A-7G allow fabrication of a hybrid lens with a sufficient tolerance to compensate for diameter (thickness) variations within the ball lens 63a or the half ball lens 63b by pressing the ball lens 63a or the half ball lens 64b flatly with the glass plate 64 while maintaining the fluidity of the photopolymer 62. Thus, it is possible to minimize a tilt of the ball lens 63a or the half ball lens 63b.

The hybrid lens, a method of fabricating the same, and a method of fabricating a mold with a cavity array for the hybrid lens according to embodiments of the present invention offer several advantages over conventional ones.

First, the method for fabricating a hybrid refractive-diffractive lens eliminates the need for a high temperature heating or cooling process or a high pressure process like glass molding when fabricating a refractive lens while allowing rapid and simple processing at room temperature under low pressure and thus high volume production.

Second, the present invention allows wafer level fabrication of a lens array by a simple process, thereby enabling high volume production. Third, the present invention allows fabrication of a refractive lens at room temperature under low pressure, thus preventing any deformation of the mold due to thermally induced expansion/contraction, fatigue, and abrasion due to high pressure. Thus, it is possible to significantly increase the lifespan of the mold.

Fourth, the hybrid lens offers excellent thermal stability and durability at a blue wavelength region over a plastic lens since a thermally stable half ball lens occupies a significant percentage of the total volume of a lens and a diffractive lens material occupies a minimum space and is used for correcting spherical aberration and forming a diffractive lens. Fifth, the present invention provides a half ball lens with a high refractive index n (e.g., 1.7<n<2.2), thus realizing a slim lens with a high NA of 0.85 comparable to that achieved by optically arranging and assembling two plastic lenses.

Sixth, the present invention uses a ball lens or a half ball lens in manufacturing a refractive lens to minimize a decenter or tilt of a lens and thus wave aberration, thereby providing a lens with excellent optical performance.

Seventh, the present invention allows a hybrid lens array to be divided into single lenses by dicing while facilitating easy handling and assembling with a holder substrate due to the presence of a holder.

Eighth, the present invention allows the hybrid lens array to be handled as a wafer, thereby facilitating alignment and assembling with an optical module array. Ninth, in contrast to a conventional mold fabrication method that individually forms each cavity with an aspheric surface and a diffractive lens pattern by machining such as cutting or grinding, the mold fabrication method of the present invention involves forming a semi-hemispherical cavity array at one time and pressing each cavity with a convex type mold with an aspheric surface and a diffractive lens pattern, and fabricating an aspheric cavity surface and a diffractive lens that occupies a minimum volume. The present invention allows fabrication of a mold for the hybrid lens in the shortest time at minimum temperature and pressure.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A hybrid lens comprising:
a refractive lens including a first spherical surface and a second planar surface;
a diffractive lens that is bonded onto the first surface of the refractive lens and includes a refractive portion for correcting spherical aberration; and
a lens holder attached to an outer perimeter of the first surface of the refractive lens.

2. The hybrid lens of claim 1, wherein the lens holder is attached to a portion of the first surface near a boundary between the first and second surfaces of the refractive lens.

3. The hybrid lens of claim 1, wherein the refractive lens is a half ball lens.

4. The hybrid lens of claim 1, wherein the refractive lens is made of glass.

5. The hybrid lens of claim 1, wherein the diffractive lens is made of polymer or an inorganic sol-gel material that can be cured by ultraviolet (UV) radiation.

6. The hybrid lens of claim 1, wherein the lens holder is made of UV curable polymer or thermosetting polymer.

7. The hybrid lens of claim 1, further comprising a holder substrate disposed beneath the second surface of the refractive lens and the holder.

8. A method of fabricating a hybrid lens, comprising:
applying a first material within a cavity of a mold including at least one cavity with a diffractive lens pattern and placing a ball lens on the first material;
pressing the ball lens and curing the first material;
applying a second material on the mold and the ball lens, pressing the ball lens, and curing the second material; and
separating the mold from the second material and the ball lens and polishing portions of the second material and the ball lens.

9. The method of claim 8, wherein the first material is a polymer or an inorganic sol-gel material that can be cured by ultraviolet (UV) radiation.

10. The method of claim 9, wherein in the pressing of the ball lens and curing of the first material a transparent plate is used, and the first material is irradiated with UV light from above the transparent plate to cure the first material.

11. The method of claim 8, wherein the second material is UV curable or thermosetting polymer.

12. The method of claim 11, wherein in the pressing of the ball lens and curing of the second material, the ball lens and the second material are pressed with a transparent plate and the second material is irradiated with UV light from above the transparent plate to cure it.

13. A method of fabricating a hybrid lens, comprising:
applying a first material within a cavity of a mold including at least one cavity with a diffractive lens pattern and placing a half ball lens on the first material;
applying a second material on the mold and the half ball lens, pressing the half ball lens, and curing the second material; and
separating the mold from the second material and the half ball lens.

14. The method of claim 13, wherein the first material is a polymer or an inorganic sol-gel material that can be cured by ultraviolet (UV) radiation.

15. The method of claim 13, wherein the second material is UV curable or thermosetting polymer.

16. The method of claim 13, wherein in the pressing of the half ball lens and the curing of the second material, the half ball lens and the second material are pressed with a transparent plate and the second material is irradiated with UV light from above the transparent plate to cure the second material.

17. A method of fabricating a mold for a hybrid lens, comprising:
applying photoresist over a substrate and removing predetermined portions of the photoresist to form grooves;
removing a portion of the substrate by isotropic etching through the groove and removing the photoresist to create a hemispherical cavity on the substrate; and
pressing a cavity with a mold with a diffractive lens pattern and forming a diffractive lens pattern within the cavity.
